(19) United States
(12) Patent Application Publication
(10) Pub. No.: US 2026/0342916 A1
(43) Pub. Date: Oct. 29, 2026

(54) SYSTEMS AND METHODS FOR MANAGING CONTACT CENTER INTERACTIONS

(71) Applicant: KORE.AI, INC., Orlando, FL (US)

(72) Inventors: Rajkumar KONERU, Windermere, FL (US); Prasanna Kumar Arikala GUNALAN, Hyderabad (IN); Venkata Praveen Kumar SUVANAM, Plainsboro, NJ (US); Ruchi GUPTA, Los Gatos, CA (US)

(21) Appl. No.: 19/190,261

(22) Filed: Apr. 25, 2025

(51) Int. Cl. H04M 3/51; H04M 3/527

(52) U.S. Cl. CPC H04M 3/5175; H04M 3/527

(57) ABSTRACT

An automation server monitors an interaction between a human agent at an agent device and a user at a user device. The automation server, based on the monitoring, determines a takeover plan for an automation agent managed by the automation server to takeover the interaction from the agent device. The automation server provides to the agent device, a takeover indication to takeover the interaction, wherein the takeover indication comprises a takeover plan and a takeover request. Further, the automation server receives an approval from the agent device to takeover the interaction and automatically continues the interaction with the user device based on the takeover plan.

This technology generally relates to contact center interactions, and more particularly to methods, systems, and computer-readable media for managing contact center interactions.

### BACKGROUND

Enterprises are increasingly relying on artificial intelligence (AI) techniques to enhance contact center operations, where customer facing virtual assistants are deployed as a first line of interaction with the contact center. These customer facing virtual assistants use AI techniques to interpret customer requests and generate responses. AI techniques, in addition to assisting customers directly, are also used to support human agents by suggesting responses, recommending relevant knowledge articles, proposing next best actions, and summarizing conversations. However, these AI systems have limited capabilities in managing complex interactions.

In some use cases, contact center interactions are transferred from customer facing virtual assistants to human agents automatically based on pre-defined conditions. For example, when a sentiment score of a virtual assistant interaction with a customer falls below a pre-defined threshold, the interaction is transferred to a human agent. In such transfers, limited information such as a transcript of the interaction, a summary of the interaction, or a sentiment score of the interaction is provided to the human agent. This information, though important, does not help the human agent make quick decisions on how to take the interaction forward.

In other examples, contact center interactions are transferred from human agents to virtual assistants manually by the human agents. For example, after handling the main aspects of an interaction with the customer, the human agent may manually transfer the interaction to the virtual assistant to perform one or more minor functions such as, for example, fill a form or collect a payment. While this approach allows the human agents to focus on more complex tasks, the transfers are dependent on the human agents determining when to transfer the interaction to the virtual assistants. Further, the virtual assistant to which the interaction is transferred may not be the appropriate virtual assistant to handle the interaction or may not be able to perform the function satisfactorily resulting in customer frustration.

Accordingly, there is a need for improved systems and methods for automating contact center interactions.

### SUMMARY

In one example, the present disclosure relates to a method for managing contact center interactions. An automation server monitors an interaction between a human agent at an agent device and a user at a user device. Based on the monitoring a takeover plan for an automation agent managed by the automation server to takeover the interaction from the agent device is determined. A takeover indication to takeover the interaction is provided, wherein the takeover indication comprises a takeover plan and a takeover request. The automation server receives an approval from the agent device to takeover the interaction and automatically continues the interaction with the user device based on the takeover plan.

In another example, the present disclosure relates to an automation server for monitoring an interaction between a human agent at an agent device and a user at a user device. Based on the monitoring a takeover plan for an automation agent managed by the automation server to takeover the interaction from the agent device is determined. A takeover indication to takeover the interaction is provided, wherein the takeover indication comprises a takeover plan and a takeover request. The automation server receives an approval from the agent device to takeover the interaction and automatically continues the interaction with the user device based on the takeover plan

In another example, the present disclosure relates to a non-transitory computer readable storage medium storing thereon instructions which when executed by one or more processors, causes the one or more processors to monitor an interaction between a human agent at an agent device and a user at a user device. Based on the monitoring a takeover plan for an automation agent managed by the automation server to takeover the interaction from the agent device is determined. A takeover indication to takeover the interaction is provided, wherein the takeover indication comprises a takeover plan and a takeover request. The automation server receives an approval from the agent device to takeover the interaction and automatically continues the interaction with the user device based on the takeover plan.

### BRIEF DESCRIPTION OF THE DRAWINGS

FIG. 1 is a block diagram of an exemplary contact center environment for implementing the concepts and technologies disclosed herein.

FIG. 2 is a flowchart of an exemplary method for taking over a contact center interaction from a human agent at an agent device.

FIG. 3A illustrates an example agent graphical user interface displayed on a human agent device and an interaction between a human agent at the human agent device and a user at a user device.

FIG. 3B is another exemplary agent graphical user interface illustrating a continuation of the interaction of FIG. 3A comprising a takeover plan provided to the human agent at the human agent device.

FIG. 3C is another exemplary agent graphical user interface illustrating another continuation of the interaction of FIG. 3A comprising an alternative takeover plan provided to the human agent at the human agent device.

FIG. 4 is another exemplary agent graphical user interface illustrating is a handover summary provided to the human agent at the human agent device by the automation agent upon a failure of the execution of the takeover plan.

FIG. 5 is another exemplary agent graphical user interface illustrating additional details provided in the handover summary.

### DETAILED DESCRIPTION

Examples of the present disclosure relate to a contact center environment and, more particularly, to one or more components, systems, computer-readable media, and methods for managing contact center interactions. Enterprises operate and outsource contact centers staffed by human agents to provide customer support. These human agents handle inquiries, resolve issues, and enhance customer satisfaction through real-time interactions.

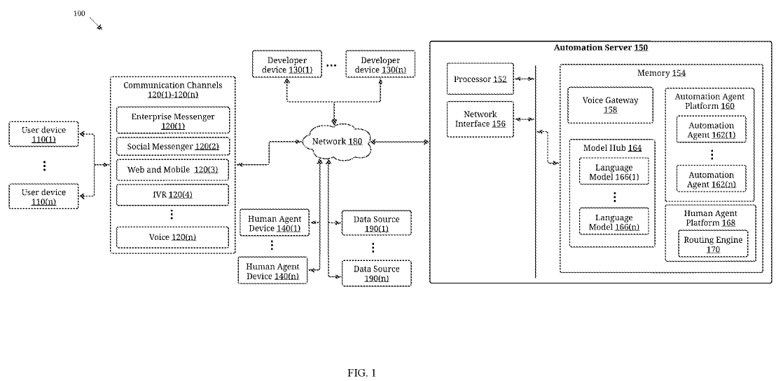

FIG. 1 is a block diagram of an exemplary contact center environment 100 for implementing the concepts and technologies disclosed herein. The contact center environment 100 in this example includes: one or more user devices 110(1)-110(n), one or more communication channels 120(1)-120(n), one or more developer devices 130(1)-130(n), one or more human agent devices 140(1)-140(n), an automation server 150, and one or more data sources 190(1)-190(n), coupled together via a network 180, although the contact center environment 100 can include other types and/or numbers of systems, devices, components, and/or elements in other examples. The contact center environment 100 can be or may include a cloud computing system, a distributed computing system, or a clustered computing system, although the contact center environment 100 may include other types and/or numbers of computing systems in other examples. Although not shown, the exemplary contact environment 100 may include additional network components, such as gateways, routers, switches and other devices, which are well known to those of ordinary skill in the art and thus will not be described here.

Referring more specifically to FIG. 1, the automation server 150 is coupled to other components in the contact center environment 100 through the network 180, although the automation server 150 and the other components in the contact center environment 100 may be coupled via other topologies or methods. The automation server 150 may use automation, human agents, or a combination of these to respond to the incoming communication and resolve issues of users at the one or more user devices 110(1)-110(n), although the automation server 150 may perform other types and/or numbers of functions in other examples. The automation server 150 enables communication between the one or more user devices 110(1)-110(n) and the one or more human agent devices 140(1)-140(n). Further, the automation server 150 enables one or more developers at the one or more developer devices 130(1)-130(n) to create, configure, manage, test, deploy, and optimize one or more automation agents which enable interactions with the one or more users at the one or more user devices 110(1)-110(n). In one example, the automation server 150 may use artificial intelligence techniques to perform the automation.

The automation server 150 includes a processor 152, a memory 154, and a network interface 156, although the automation server 150 may include other types and/or numbers of components in other examples. Although one processor 152, one memory 154, and one network interface 156 are illustrated, it may be understood that there may be a plurality of: processor 152, memory 154, or network interface 156 components in other examples. In addition, the automation server 150 may include an operating system (not shown). In one example, the automation server 150 and/or processes performed by the automation server 150 may be implemented using a networking environment (e.g., cloud computing environment) or offered as a service through the cloud computing environment. This enables enterprises to manage customer communications and interactions via the internet.

The components of the automation server 150 may be coupled by a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, an Small Computer Systems Interface (SCSI) bus, or a combination of two or more of these, although the components of the automation server 150 may be coupled using other types and/or numbers of buses or systems in other examples. In one example, the components of the automation server 150 may be operatively or communicatively coupled with each other.

The processor 152 of the automation server 150 may execute one or more computer-executable instructions stored in the memory 154 for developing and managing artificial intelligence applications using automation agents, such as the methods illustrated and described with reference to the examples herein, although the processor 152 can execute other types and/or numbers of instructions and perform other types and/or numbers of operations. The processor 152 may comprise: one or more central processing units (CPUs) with one or more cores and a cache memory for local storage of data and instructions, although the processor 152 may comprise other types and/or numbers of components in other examples. The functions of the processor 152 may be spread across multiple linked or networked devices or modules.

The memory 154 of the automation server 150 is an example of a non-transitory computer readable storage medium capable of storing information or instructions for the processor 152 to execute. The instructions, which when executed by the processor 152, perform one or more of the disclosed examples. The memory 154 includes one or more memory components, which may each be a volatile memory or a non-volatile memory. In one example, the memory 154 may be a random access memory (RAM), a dynamic random access memory (DRAM), a static random access memory (SRAM), a persistent memory (PMEM), a nonvolatile dual in-line memory module (NVDIMM), a hard disk drive (HDD), a read only memory (ROM), an erasable programmable read-only memory (EPROM), an electrically erasable programmable read-only memory (EEPROM), a programmable ROM (PROM), a flash memory, a solid state memory, a compact disc (CD), a digital video disc (DVD), a magnetic disk, a universal serial bus (USB) memory card, a memory stick, or any other memory storage types or devices, including combinations thereof, which are known to those of ordinary skill in the art. It may be understood that the memory 154 may include other electronic, magnetic, optical, electromagnetic, infrared or semiconductor based non-transitory computer readable storage medium which may be used to tangibly store instructions, which when executed by the processor 152, perform the disclosed examples. The non-transitory computer readable medium is not a transitory signal per se and is any tangible medium that contains and stores the instructions for use by or in connection with an instruction execution system, apparatus, or device. Examples of the programmed instructions and steps stored in the memory 154 are illustrated and described by way of the description and examples herein.

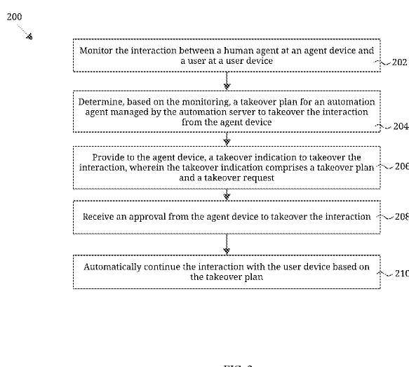

Accordingly, the memory 154 of the automation server 150 can store computer executable instructions that, when executed by the automation server 150, causes the automation server 150 to perform actions, such as to transmit, receive, or otherwise process text data or voice data, for example, and to perform other actions described and illustrated below with reference to FIGS. 2, 3A-3C, 4 and 5, although the automation server 150 may perform other types and/or numbers of actions in other examples. The memory 154 comprises data and instructions which when executed by the processor 152 provide web-based services to the one or more user devices 110(1)-110(n) or the one or more developer devices 130(1)-130(n), although the memory 154 comprises other types and/or numbers of data or instructions in other examples.

As illustrated in FIG. 1, the memory 154 comprises instructions or data corresponding to a voice gateway 158, an automation agent platform 160, a model hub 164, and a human agent platform 168, although other types and/or numbers of data or instructions in the form of programs, functions, methods, procedures, definitions, subroutines, modules, structured data, or unstructured data may be stored in other examples. One or more components of the memory 154 may be operatively coupled and communicate with each other. The automation server 150 receives communication from the one or more user devices 110(1)-110(n) and provides responses to the communication.

In some examples, one or more components of the automation server 150 may be implemented on one or more servers such as an application server, a database server, or a telephony server, although the one or more components of the automation server 150 may be implemented on other types and/or numbers of devices in other examples. In some examples, the one or more servers may be hardware servers or non-hardware servers. The automation server 150 runs web-based software services deliverable to a client, for example: the one or more user devices 110(1)-110(n), or the one or more developer devices 130(1)-130(n), or the one or more human agent devices 140(1)-140(n). The software services may be the voice gateway 158, the automation agent platform 160, the model hub 164, or the human agent platform 168.

The voice gateway 158 enables communications in voice mode with the automation server 150. The voice gateway 158 handles incoming voice calls from the one or more user devices 110(1)-110(n), and responds to these voice calls based on a voice program aligned with the communication routing setup of the automation server 150. The voice program may be a script in a scripting language such as voice extensible markup language (VXML). The voice gateway 158 interacts with the one or more applications of the automation server 150, the one or more user devices 110(1)- 110(n), a speech-to-text server (STT server), and a text-to-speech (TTS server) to drive user conversations. In one example, the voice gateway 158 may comprise a session initiation protocol orchestrator (SIP orchestrator) (not shown) and a media manager (not shown), although there may be other types and/or numbers of components in other examples. The SIP orchestrator orchestrates communication with various components and the media manager manages all the media for the voice gateway 158 and orchestrates with the STT server, and the TTS server. The voice gateway 158 may support standards and/or formats such as, for example, voiceXML, JavaScript Object Notation (JSON), Call Control eXtensible Markup Language (CCXML), or Speech Application Language Tags (SALT), although other types and/or numbers of formats may be supported by the voice gateway 158 in other examples.

The automation agent platform 160 enables one or more developers at the one or more developer devices 130(1)-130(n) to create, configure, manage, test, optimize, or deploy one or more automation agents 162(1)-162(n), for example, through tools and interfaces designed for defining use cases and interaction rules. The one or more developers tailor the one or more automation agents 162(1)-162(n) to specific business requirements using graphical user interfaces or APIs, although other types and/or numbers of methods may be used in other examples. In one example, the one or more automation agents 162(1)-162(n) may be artificial intelligence agents with perception, reasoning, action, and learning capabilities, although there may be other types and/or numbers of capabilities in other examples.

The one or more automation agents 162(1)-162(n) may be powered by one or more language models 166(1)-166(n). The model hub 164 hosts and manages the one or more language models 166(1)-166(n) and provides a user interface for the one or more developer devices 130(1)-130(n) to train, fine-tune, configure, or deploy the one or more language models 166(1)-166(n). The one or more language models 166(1)-166(n) may perform tasks including executing prompts provided by the one or more automation agents 162(1)-162(n), interpreting user utterances, identifying use cases from the user utterances, generating appropriate responses, summarizing contact center interactions, generating response recommendations to human agents, extract insights from contact center interactions, although other types and/or numbers of tasks may be performed. The one or more language models 166(1)-166(n) may be lightweight models, small language models, or large language models. The one or more language models 166(1)-166(n) within the model hub 164 can handle diverse input types, including text, images, or multimodal data that combines text, voice, and other media.

The automation agent platform 160 also delivers web services to clients such as the one or more human agent devices 140(1)-140(n). In one example, these web services may include delivering a human agent software comprising one or more human agent user interfaces (hereinafter referred to as agent GUIs) for the one or more human agents at the one or more human agent devices 140(1)-140(n). The human agent software is a desktop or mobile application that enables human agents to effectively manage user (e.g. customer) interactions. The one or more agent GUIs includes interfaces for human agents to interact with the one or more automation agents 162(1)-162(n), artificial intelligence (AI) tools, or other necessary tools and information to handle user interactions. The agent GUI includes options to access a user database, product details, company knowledge bases, and user interaction history, response recommendations and assistance, search capabilities, interaction summary, interaction stage, and other interaction management tools ensuring agents have a complete view of each customer’s journey, although other types and/or numbers of information may be included in other examples. The automation agent platform 160 dynamically generates and transmits the agent GUI data based on, for example, inputs provided by the human agents or human agent interaction at the one or more human agent devices 140(1)-140(n).

The human agent platform 168 of the automation server 150 facilitates communication between the automation server 150 and the one or more agent devices 140(1)-140(n). The human agent platform 168 includes a routing engine 170 which handles routing the user interactions to the one or more agent devices 140(1)-140(n), although the human agent platform 168 may include other types and/or numbers of components in other configurations. In one example, the routing engine 170 manages transferring a user interaction handled by one of the one or more automation agents 162(1)-162(n) to the one or more human agent devices 140(1)-140(n). In another example, messages from the automation agent platform 160 may be output to the one or more human agent devices 140(1)-140(n). The routing engine 170 may be configured with artificial intelligence techniques including one or more: language models, predictive models, rules, programming modules, or routing algorithms that are executable by the processor 152 to route one or more user interactions to the human agents at the one or more human agent devices 140(1)-140(n).

The one or more user devices 110(1)-110(n) may comprise one or more processors, one or more memories, one or more input devices such as a keyboard, a mouse, a display device, a touch interface, and/or one or more communication interfaces, which may be coupled together by a bus or other link, although the one or more user devices 110(1)-110(n) may have other types and/or numbers of other systems, devices, components, and/or elements in other examples.

The one or more user devices 110(1)-110(n) may communicate with the automation server 150 via the network 180. The users may access and interact with the software services offered by the automation server 150 via the one or more user devices 110(1)-110(n). The one or more user devices 110(1)-110(n) may comprise any type of computing device that can facilitate user interaction, for example, a desktop computer, a laptop computer, a tablet computer, a smartphone, a mobile phone, a wearable computing device, or any other type of device with communication and data exchange capabilities. Also, the one or more user devices 110(1)-110(n) may render and display the information received from the automation server 150. The automation server 150 is configured to deliver one or more graphical user interfaces (GUIs) to the one or more user devices 110(1)-110(n) over the network 180. The automation server 150 dynamically generates and transmits the GUI data based on, for example, user inputs or user interaction at the one or more user devices 110(1)-110(n). In one example, the one or more user devices 110(1)-110(n) may render an interface of any of the one or more communication channels 120(1)-120(n) using which the users may communicate with the automation server 150. In another example, the one or more user devices 110(1)-110(n) may render a graphical user interface of the one or more automation agents 162(1)-162(n) with which the users may communicate. The one or more user devices 110(1)-110(n) and the automation server 150 may communicate via one or more application programming interfaces (APIs) or one or more hyperlinks exposed by the automation server 150.

The users may communicate with the automation server 150 by providing text-based query or voice-based query via any of the one or more communication channels 120(1)-120(n). The one or more communication channels 120(1)-120(n) may comprise channels such as, for example, enterprise messengers 120(1) (e.g., Skype for Business, Microsoft Teams, Kore.ai WorkAssist, Slack, or the like), social messengers 120(2) (e.g., Facebook Messenger, Twitter, Telegram, or the like), web & mobile 120(3) (e.g., a web application, a mobile application), interactive voice response (IVR) 120(4), voice channels 120(n) (e.g., Amazon Alexa, Twilio Voice, or the like), a webhook, a short messaging service (SMS), email, a software-as-a-service (SaaS) application, or the like. Examples of the voice channel 120 may include telephone calls made over mobile phones or landlines, voice over IP or VoIP calls, computer telephony calls, although there may be other types and/or numbers of technologies in other examples. It may be understood that to support voice-based communication channels, the contact center environment 100 may comprise, for example, a public switched telephone network (PSTN), a voice server, a media server, a text-to-speech (TTS) engine, and an automatic speech recognition (ASR) engine, which are not illustrated in FIG. 1.

The one or more human agent devices 140(1)-140(n) may comprise one or more processors, one or more memories, one or more input devices such as a keyboard, a mouse, a display device, a touch interface, and/or one or more communication interfaces, which may be coupled together by a bus or other link, although the one or more human agent devices 140(1)-140(n) may have other types and/or numbers of other systems, devices, components, and/or elements in other examples.

One or more developers may access the software services provided by the automation server 150 via the network 180 using the one or more developer devices 130(1)-130(n). The one or more developer devices 130(1)-130(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more developer devices 130(1)-130(n) may include software and hardware capable of communicating with the automation server 150 via the network 180. Also, the one or more developer devices 130(1)-130(n) may comprise a GUI (not shown) to render and display the information received from the automation server 150. The one or more developer devices 130(1)-130(n) may communicate with the automation server 150 via one or more APIs or one or more hyperlinks exposed by the automation server 150, although other types and/or numbers of communication methods may be used in other examples.

The one or more data sources 190(1)-190(n) may comprise a database, a repository, or other information sources containing user data, enterprise data, or interaction data, although other types and/or numbers of information may be included in other examples. The one or more data sources 190(1)-190(n) may include Customer Relationship Management (CRM) systems, Enterprise Resource Planning (ERP) systems, interaction data repositories, knowledge bases, user feedback sources, or external APIs, although there may be other types and/or numbers of data sources in other examples. The automation server 150 adds to or queries these sources, for example, via APIs to add or retrieve information, enabling the automation server 150 to efficiently manage interactions. In one example, the automation server 150 queries the one or more data sources 190(1)-190(n) to provide information corresponding to an interaction to a human agent at the human agent device 140(1). In another example, the automation server 150 adds an interaction history to a data source 190(1).

The network 180 enables the components of the contact center environment 100 to communicate with the automation server 150. The network 180 may be, for example, an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, a worldwide interoperability for microwave access (WiMAX) network, or a combination of two or more such networks, although the network 180 may include other types and/or numbers of networks in other topologies or configurations.

The network interface 156 may include hardware, software, or a combination of hardware and software, enabling the automation server 150 to communicate with the components illustrated in the contact center environment 100, although the network interface 156 may enable communications with other types and/or number of components in other examples. In one example, the network interface 156 provides interfaces between the automation server 150 and the network 180. The network interface 156 may support wired or wireless communications. In one example, the network interface 156 may include an Ethernet adapter or a wireless network adapter to communicate with the network 180.

An enterprise user, such as a developer or a business analyst at the one or more developer devices 130(1)-130(n) by way of example, may create or configure the one or more automation agents 162(1)-162(n) using the automation agent platform 160 of the automation server 150. When a user at, for example, the user device 110(1) communicates with the automation server 150 via a user interface of the automation agent 162(1), the automation server 150 may provide a response to the user communication by communicating with the one or more components of the automation server 150 or one or more other components of the contact center environment 100, although the response may be provided by communicating with other types and/or numbers of applications or components in other examples.

The one or more automation agents 162(1)-162(n) may monitor the interactions of the one or more user devices 110(1)-110(n) with the one or more human agent devices 140(1)-140(n). In one example, the automation agent 162(1) monitors the interaction between the user device 110(1) and the human agent device 140(1). In response to the messages received from the user device 110(1), the automation agent 162(1) provides response recommendations or action suggestions to the human agent device 140(1), for example, based on context, historical data, business rules, although other types of data may be used in other examples.

The response recommendations may be a response to a user message. The action suggestion may be a suggestion of: a takeover of the interaction by the automation agent 162(1), converting the interaction to a conference by adding a human agent at another one of the one or more human agent devices 140(1)-140(n) or another one of the one or more automation agents 162(1)-162(n), deleting a human agent at another one of the one or more human agent devices 140(1)-140(n) or another one of the one or more automation agents 162(1)-162(n) from the conference, handover the interaction to a human agent at another one of the one or more human agent devices 140(1)-140(n) or another one of the one or more automation agents 162(1)-162(n). In addition to the response recommendations or the action suggestions, the automation server 150 may also provide: data corresponding to the user or the interaction, relevant knowledge sources, or a conversation history of the user, although other types of data may be provided in other examples.

FIG. 2 is a flowchart of an exemplary method 200 for taking over a contact center interaction from a human agent device 140(1). The exemplary method 200 may be performed by the system components illustrated in the contact center environment 100 of FIG. 1.

In this example, at step 202, the automation server 150 monitors an interaction between the human agent at the human agent device 140(1) and a user at the user device 110(1). In one example, the monitoring may comprise providing a transcript of the interaction to the automation agent 162(1) of the automation server 150 after receiving each user message from the user device 110(1) or after providing each human agent message to the user device 110(1), although the monitoring may also be performed in other manners and at other time periods. During the monitoring, the automation agent 162(1) may determine parameters such as a use case of the interaction, a sentiment of the interaction, a duration of the interaction, by way of example only, although other types and/or numbers of parameters may be determined.

At step 204, the automation server 150 determines one or more steps of a takeover plan for an automation agent 162(1) managed by the automation server 150 to takeover the interaction from the human agent device 140(1). For example, during the monitoring, the automation agent 162(1) of the automation server 150 analyzes the transcript of the interaction and tries to determine one or more steps of a takeover plan after receiving each user message from the user device 110(1) or after providing each human agent message to the user device 110(1). The automation agent 162(1) may also determine one or more steps of a takeover plan after the sentiment of the interaction falls below a threshold. The automation agent 162(1) may also determine the one or more steps of a takeover plan based on user factors, such as a customer category of the user, such as standard, gold, platinum, or the like.

For example, the takeover plan comprises one or more steps to be executed by the automation agent 162(1) to continue the interaction with the user device 110(1). Further, the takeover plan may include names of one or more tools or one or more data sources used to execute the one or more steps. For example, the takeover plan comprises: step 1 (tool to be used: tool 1), step 2 (data sources to be used: source 1, source 4).

Determining the takeover plan may be performed using various methods. In one example, upon analyzing the transcript, the automation agent 162(1) may determine a use case of the interaction such as: transfer funds, book flight, or raise a ticket, although other types and/or numbers of use cases may be determined. Based on the use case, the automation agent 162(1) may determine that the interaction may be taken over and that an indication to takeover the interaction needs to be transmitted to the human agent at the human agent device 140(1). For example, the automation server 150 may be configured with an automation flow corresponding to the use case – transfer funds. When the use case of the interaction is determined as – transfer funds, the automation agent 162(1) may provide an indication that the automation flow will be executed as part of the takeover plan. In another example the automation agent 162(1) may, based on historical interactions corresponding to the use case, determine the takeover plan and provide the indication to takeover the interaction to the human agent at the human agent device 140(1).

The automation agent 162(1), upon analyzing the transcript, may determine a solution to a user message (e.g. a query) in the interaction from one or more knowledge sources or by performing one or more API calls and determine that the interaction may be taken over. For example, the automation agent 162(1) may analyze the transcript and determine that the user has a password reset issue. The automation agent 162(1) may execute a search in one or more data sources 190(1)-190(n) and determine one or more steps to solve the issue. Subsequently, the automation agent 162(1) may provide an indication comprising: a takeover plan comprising the one or more steps to takeover the interaction and a takeover request comprising options, for example, to approve, reject, or to edit and then approve takeover. The automation agent 162(1) may, in one example, combine the search results to determine the one or more steps. Subsequent to determining the one or more steps, the automation agent 162(1) may provide an interaction indication comprising the one or more steps to takeover the interaction to the human agent at the human agent device 140(1).

In another example, upon analyzing the transcript, the automation agent 162(1) may determine that the subsequent steps in the interaction involve information collection from the user device 110(1). As a result, the automation agent 162(1) may determine that a deterministic workflow that may be executed to collect the information and as a result that an interaction indication to takeover at least a part of the interaction may be taken over and needs to be transmitted to the human agent at the human agent device 140(1).

In another example, upon analyzing the transcript, the automation agent 162(1) may determine a takeover plan based on one or more historical conversations managed by the automation server 150. For example, the automation agent 162(1) may determine the use case of the interaction and analyze methods performed, tools used, data sources queried, APIs called in historical conversations of the use case and determine the one or more steps of the takeover plan, although other factors may be used to determine the takeover plan. For example, in a historical conversation, the automation agent 162(1) may have provided a solution to the user query by executing a deterministic flow corresponding to the use case. In another historical conversation, the automation agent 162(1) may have provided a solution to the user query by retrieving data from one or more data sources and then executing one or more tools.

At step 206, the automation server 150 provides to the human agent device 140(1), a takeover indication, comprising for example a takeover request for all or part of the interaction and/or of the takeover plan, to takeover the interaction.

At step 208, the automation server 150 receives an approval from the human agent device 140(1) to takeover the interaction in response to the takeover indication, although other responses may be received. For example, the automation server 150 may receive an approval from the human agent device 140(1) to takeover one or more parts, but not all of the interaction or may approve a subset of the steps of the interaction plan.

At step 210, the automation agent 162(1) of the automation server 150 takes over the interaction and automatically continues the interaction with the user device 110(1) based on approved portion or all of the takeover plan. In one example, the automation server 150 provides an indication to the user device 110(1) about the automation of all or part of the interaction approved by the human agent 140(1) and only takes over all or part of the interaction upon receiving an approval from the user device 110(1).

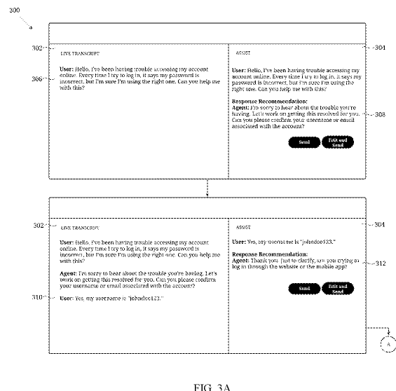

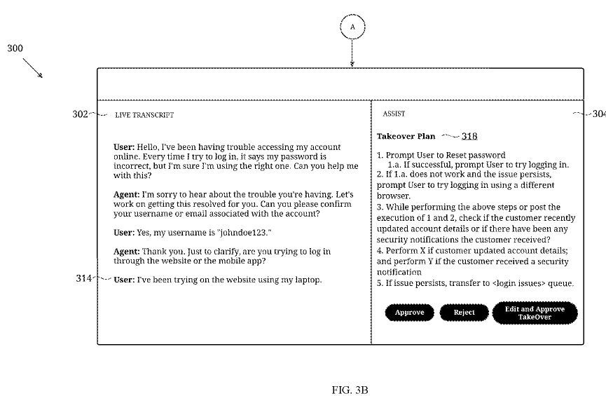

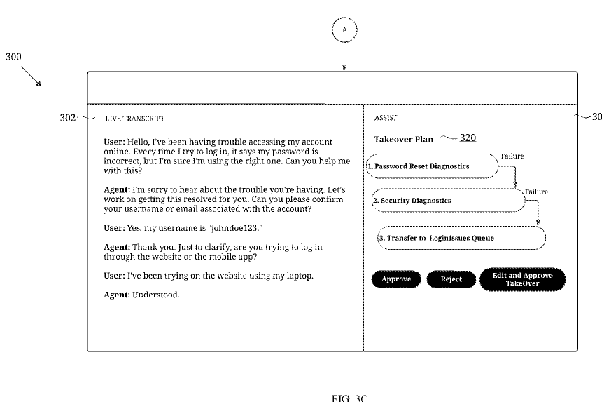

For further illustration, in one example, the one or more automation agents 162(1)-162(n) may be configured in an agentic artificial intelligence architecture. The automation agent 162(1) may be a supervisor agent and communicate with the one or more automation agents 162(2)-162(n) to provide the takeover plan. In another example, the one or more automation agents 162(1)-162(n) may monitor the interactions of the one or more user devices 110(1)-110(n) with the one or more human agent devices 140(1)-140(n), and a combination of the one or more automation agents 162(1)-162(n) may provide the takeover plan. As illustrated in the assist 304 section of FIG. 3A, the human agent at the human agent device 140(1) may only see, for example, the response recommendation or the takeover plan and the one or more automation agents 162(1)-162(n) providing the response recommendation or the takeover plan may be abstracted.

FIG. 3A illustrates an example agent GUI 300 displayed on, for example, a human agent device 140(1) and an interaction between a human agent at the human agent device 140(1) and, for example, a user at the user device 110(1). The agent GUI 300 is broken into two main sections comprising: live transcript 302 and assist 304, although there may be other types and/or numbers of sections in other examples. The live transcript 302 section displays the transcript of the interaction between the human agent at the human agent device 140(1) and the user at the user device 110(1). The assist 304 section displays one or more user messages, one or more response recommendations, action suggestions, or a takeover plan for the automation server 150 to takeover the interaction from the human agent at the human agent device 140(1), although other types and/or numbers of recommendations or information may be provided in other examples.

The automation server 150 may act as an interface between the human agent device 140(1) and the user device 110(1) routing all the messages of the interaction. The automation server 150 monitors the interaction between the user device 110(1) and the human agent device 140(1) and provides assistance to the human agent at the human agent device 140(1) to respond to the user. In one example, the monitoring may comprise providing each user message received by the automation server 150 to an automation agent 162(1) and providing assistance may comprise providing the corresponding response of the automation agent 162(1) to the human agent at the human agent device 140(1).

A first user message 306 is displayed in the live transcript 302 section of the agent GUI 300 and a first response recommendation 308 is displayed in the assist 304 section of the agent GUI 300. Upon receiving the first user message 306, the automation server 150 provides the first user message 306 and a corresponding first response recommendation 308 to the human agent device 140(1).

The human agent may send as-is, as a first response to the first user message 306, the first response recommendation 308 to the user device 110(1). Alternatively, the human agent may edit the first response recommendation 308 and send the edited first response recommendation 308 to the user device 110(1). In another example, the human agent may not choose to use the first response recommendation 308 and provide a custom response to the user device 110(1).

Upon receiving the first response, the user at the user device 110(1) may provide a second user message 310. Upon receiving the second user message 310, the automation server 150 provides the second user message 310 and a corresponding second response recommendation 312 to the human agent device 140(1).

FIG. 3B is another exemplary agent GUI 300 illustrating a continuation of the interaction of FIG. 3A comprising a takeover plan 318 provided to the human agent at the human agent device 140(1). After receiving a third user message 314, the automation server 150 provides a takeover plan 318 to the human agent device 140(1). The takeover plan 318 comprises a natural language description of one or more steps to be performed by the automation server 150 to continue the interaction with the user device 110(1). In one example, the one or more steps may be performed by the one or more automation agents 162(1)-162(n). The takeover plan 318 may also comprise a name of an executable component such as a deterministic flow. For example, if the automation server 150 is configured with a deterministic flow for a use case – “password reset,” the takeover plan 318 may comprise – “execute <password reset>.” It may be understood that the takeover plan 318 may comprise natural language text, executable components, non-executable components, component identifiers, such as automation agent or tool names, or the like. The human agent at the human agent device 140(1) may approve, reject, or edit and approve part or all of the takeover plan by, for example, selecting the corresponding buttons in the assist 304 section.

When the human agent approves the takeover plan 318, the automation server 150 takes over the interaction with the user device 110(1) and provides the subsequent responses to the user device 110(1). The automation server 150 continues the interaction based on the automation steps provided in the takeover plan 318. Based on the takeover plan 318, the interaction may be removed from all or part of the interactions managed by the human agent at the human agent device 140. In another example, the interaction is not removed from the interactions managed by the human agent at the human agent device 140 and the human agent continues to supervise the interaction between the user at the user device 110(1) and the automation server 150.

When the human agent rejects the takeover plan 318, the interaction between the human agent at the human agent device 140(1) and the user at the user device 110(1) continues. Alternatively, when the human agent selects the “edit and approve takeover” option, the human agent may, for example, add, delete or modify existing one or more steps of the takeover plan 318 and approve the edited takeover plan 318. The automation server 150 continues the interaction based on the automation steps provided in the edited takeover plan 318.

FIG. 3C is another exemplary agent GUI 300 illustrating another continuation of the interaction of FIG. 3A comprising an alternative takeover plan 320 provided to the human agent at the human agent device 140(1). The steps may comprise: 1. Password reset diagnostics; and 2. Security diagnostics may be pre-defined issue resolution methods defined by the one or more developers at the one or more developer devices 130(1)-130(n). In one example, the steps 1 and 2 may comprise one or more methods used to troubleshoot password reset issues or security issues. The steps may further comprise a step 3 - Transfer to login issues queue, indicates transferring the interaction to a login issues queue managed by the automation server 150. As illustrated, the takeover plan 320 indicates performing step 1, performing step 2 when step 1 fails, and performing step 3 when step 2 fails. In one example, when the human agent at the human agent device 140 selects the edit and approve takeover plan option, the human agent may be presented with a library of predefined issue resolution methods, and the human agent may, for example, drag and drop the predefined issue resolution methods and/or add conditional logic to edit the alternative takeover plan 320.

During the interaction between the human agent device 140(1) and the user device 110(1), the automation agent 162(1) determines whether to provide a response recommendation or an action suggestion to the agent device 140(1). The automation agent 162(1) may make this determination based on one or more parameters such as, for example, a use case of the interaction, a customer category of the user, a sentiment of the interaction, one or more business rules, or the like. For example, for a user in a standard customer plan of an enterprise, the automation agent 162(1) may provide only response recommendations. Whereas for a user in a platinum customer plan of the enterprise, the automation agent 162(1) may also provide action suggestions such as conferencing by adding another human agent at another of the one or more human agent devices 140(1)-140(n) to the interaction between the human agent device 140(1) and the user device 110(1).

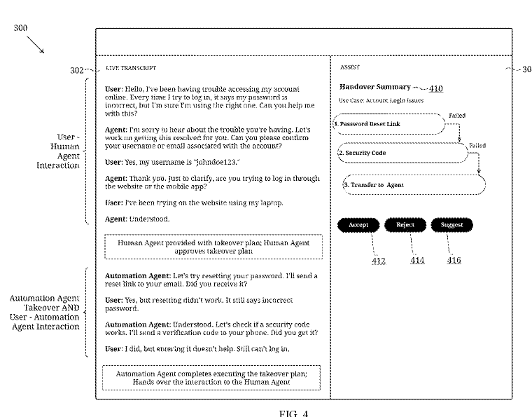

Additionally, the automation agent 162(1) may provide a handover summary to the human agent at the human agent device 140(1) upon a success, partial success, or a failure of the execution of the takeover plan 318. For example, FIG. 4 is another exemplary agent GUI 300 illustrating a handover summary 410 provided to the human agent at the human agent device 140(1) upon the failure of the execution of the takeover plan 318. The human agent at the human agent device 140(1) may review the handover summary 410 and select: accept 412, reject 414, or suggest 416 in the assist 304 section. Upon the selection of accept 412, the automation server 150 hands over the interaction to the human agent at the human agent device 140(1) and the automation agent 162(1) resumes monitoring the subsequent interaction between the user at the user device 110(1) and the human agent at the human agent device 140(1).

Upon the selection of reject 414, the automation server 150 may place the interaction in a wait queue and the automation server 150 search for another available human agent at another one of the one or more human agent devices 140(1)-140(n) to manage the interaction.

Upon the selection of suggest 416, the automation server 150 provides one or more options in the assist 304 section for the human agent to provide one or more suggestions for the automation agent 162(1) to continue the interaction. The one or more options may be: a prompt box or a dialog box for the human agent to provide a prompt for the automation agent 162(1), one or more tools, one or more knowledge sources, one or more data sources, a list of pre-defined solutions to user queries from a solution library, or a combination of these, although other types and/or numbers of options may be provided.

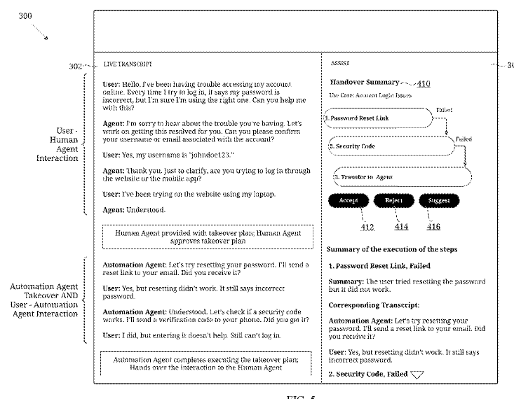

FIG. 5 is another exemplary agent GUI 300 illustrating additional details that may be provided in the handover summary 410 comprising the use case of the interaction, the steps of the takeover plan 318, and the execution status of the steps of the takeover plan 318, although other data may be included in other examples. The handover summary 410 may also comprise an execution status of the steps of the takeover plan 318 such as success, failure, partial success, or the like. Additionally, as illustrated in assist 304 section, the handover summary 410 may also comprise a summary of the execution of the steps of the takeover plan 318. For example, the summary of the execution of the steps may comprise the execution status, a reason for tagging the step with the execution status, and a part of the interaction corresponding to the step.

The handover summary 410 is illustrated and described above as performed after the automation agent 162(1) takes over the interaction, from the human agent at the human agent device 140(1), and the execution of the takeover plan 318. However, it may be understood that the user at the user device 110(1) may start the interaction with the automation agent 162(1). The automation agent 162(1) may execute one or more steps to resolve a user query and then, if the user query is not resolved, provide a handover summary 410 and handover the interaction to the human agent at the human agent device 140(1).

The interaction with the user at the user device 110(1) may be taken over or handed over multiple times before the user query or issue is fulfilled. The takeovers and the handovers may be performed with or without the knowledge and/or approval of the user at the user device 110(1).

The human agent at the human agent device 140(1) may also proactively instruct any of the one or more automation agents 162(1)-162(n) to takeover an interaction, for example, between the human agent at the human agent device 140(1) and the user at the user device 110(1). In one example, the human agent at the human agent device 140(1) may instruct an automation agent 162(2) configured to manage a use case “dispute a transaction” to takeover the interaction. In another example, the human agent at the human agent device 140(1) may provide natural language instructions to the automation server 150 to takeover the interaction. Based on the natural language instructions, one or more of the one or more automation agents 162(1)-162(n) may takeover the interaction. It may be understood that the human agent at the human agent device 140(1) may provide other types and/or numbers of instructions to the automation server 150 to takeover the interaction. The above-described exemplary methods and systems improve the management of contact center interactions by improving automation and providing the human agent more flexibility to manage the interactions.

Having thus described the basic concept of the invention, it will be rather apparent to those skilled in the art that the foregoing detailed disclosure is intended to be presented by way of example only, and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing a contact center interaction comprising:
monitoring, by an automation server, an interaction between a human agent at an agent device and a user at a user device;
determining, by the automation server, based on the monitoring, a takeover plan for an automation agent managed by the automation server to takeover the interaction from the agent device;
providing, by the automation server, to the agent device, a takeover indication to takeover the interaction, wherein the takeover indication comprises the takeover plan and a takeover request;
receiving, by the automation server, an approval from the agent device to takeover the interaction; and
automatically continuing, by the automation server, the interaction with the user device based on the takeover plan.

2. The method of claim 1, wherein the takeover plan comprises one or more steps to be executed by the automation agent to continue the interaction with the user device.

3. The method of claim 1, wherein the takeover plan includes names of one or more tools or one or more data sources to be used to execute one or more steps of the takeover plan.

4. The method of claim 1, further comprising:
transferring, by the automation server, the interaction back to the agent device when execution of the takeover plan is completed; and
providing, by the automation server, an execution status of the takeover plan to the agent device.

5. The method of claim 4, wherein the execution status comprises a summary of an indication of a successful execution or a failed execution of one or more steps of the takeover plan.

6. The method of claim 1, wherein the takeover indication comprises an indication to transfer the interaction back to the agent device subsequent to an execution of the takeover plan.

7. An automation server comprising:
one or more processors; and
a memory coupled to the one or more processors which are configured to execute programmed instructions stored in the memory to:
monitor an interaction between a human agent at an agent device and a user at a user device;
determine, based on the monitor, a takeover plan for an automation agent managed by the automation server to takeover the interaction from the agent device;
provide to the agent device, a takeover indication to takeover the interaction, wherein the takeover indication comprises the takeover plan and a takeover request;
receive an approval from the agent device to takeover the interaction; and
automatically continue the interaction with the user device based on the takeover plan.

8. The automation server of claim 7, wherein the takeover plan comprises one or more steps to be performed by the automation agent to continue the interaction with the user device.

9. The automation server of claim 7, wherein the takeover plan includes names of one or more tools or one or more data sources to be used to execute one or more steps of the takeover plan.

10. The automation server of claim 7, wherein the one or more processors are further configured to execute the programmed instructions stored in the memory to:
transfer the interaction back to the agent device when execution of the takeover plan is completed; and
provide an execution status of the takeover plan to the agent device.

11. The automation server of claim 10, wherein the execution status comprises a summary of an indication of a successful execution or a failed execution of one or more steps of the takeover plan.

12. The automation server of claim 7, wherein the takeover indication comprises an indication to transfer the interaction back to the agent device subsequent to an execution of the takeover plan.

13. A non-transitory computer readable medium storing instructions which when executed by one or more processors, causes the one or more processors to:
monitor an interaction between a human agent at an agent device and a user at a user device;
determine, based on the monitor, a takeover plan for an automation agent managed by an automation server to takeover the interaction from the agent device;
provide to the agent device, a takeover indication to takeover the interaction, wherein the takeover indication comprises the takeover plan and a takeover request;
receive an approval from the agent device to takeover the interaction; and
continue the interaction with the user device based on the takeover plan.

14. The non-transitory computer readable medium of claim 13, wherein the takeover plan comprises one or more steps to be performed by the automation agent to continue the interaction with the user device.

15. The non-transitory computer readable medium of claim 13, wherein the takeover plan includes names of one or more tools or one or more data sources to be used to execute one or more steps.

16. The non-transitory computer readable medium of claim 13, further comprising instructions which when executed by the one or more processors, causes the one or more processors to:
transfer the interaction back to the agent device when execution of the takeover plan is completed; and
provide an execution status of the takeover plan to the agent device.

17. The non-transitory computer readable medium of claim 16, wherein the execution status comprises a summary of an indication of a successful execution or a failed execution of one or more steps of the takeover plan.

18. The non-transitory computer readable medium of claim 13, wherein the takeover indication comprises an indication to transfer the interaction back to the agent device subsequent to an execution of the takeover plan.
